(19) United States
(12) Patent Application Publication
(10) Pub. No.: US 2024/0139628 A1
(43) Pub. Date: May 2, 2024

(54) STORAGE MEDIUM, GAME SYSTEM, GAME APPARATUS, AND GAME PROCESSING METHOD

(71) Applicant: NINTENDO CO., LTD., Kyoto (JP)

(72) Inventor: Takahiro OKUDA, Kyoto (JP)

(21) Appl. No.: 18/493,089

(22) Filed: Oct. 24, 2023

(30) Foreign Application Priority Data
Oct. 26, 2022 (JP) 2022-171408

(51) Int. Cl. A63F 13/57

(52) U.S. Cl. CPC A63F 13/57

(57) ABSTRACT

At least a pose that a first object having a first 3D model adopts in a virtual space is controlled. According to a first command based on an operation input, at least first pose data related to the pose of the first object at the time of the first command is stored into a storage. According to a second command based on an operation input, a second object having the first 3D model is disposed in the virtual space, in a pose based on the first pose data.

### CROSS REFERENCE TO RELATED APPLICATIONS

This application claims priority to Japanese Patent Application No. 2022-171408, filed on Oct. 26, 2022, the entire contents of which are incorporated herein by reference.

### FIELD

The technology disclosed herein relates to a storage medium, game system, game apparatus, and game processing method that execute a process using an object in a virtual space.

### BACKGROUND AND SUMMARY

There has conventionally been a game apparatus that executes a game program capable of storing captured images of landscapes and objects in a virtual space, as a user's collection elements, in a storage medium.

However, the collection elements that can be stored in the above game apparatus are limited to images of the virtual space captured by a virtual camera.

With the above in mind, it is an object of the present example to provide a non-transitory computer-readable storage medium, game system, game apparatus, and game processing method that are capable of providing a novel collection element that can be stored in a game.

To achieve the object, the present example may have features (1) to (13) below, for example.

(1) An example configuration of a non-transitory computer-readable storage medium according to the present example has stored therein instructions that, when executed, cause one or more processors of an information processing apparatus to execute game processing comprising: controlling at least a pose that a first object having a first 3D model adopts in a virtual space; according to a first command based on an operation input, storing at least first pose data related to the pose of the first object at the time of the first command into a storage; and according to a second command based on an operation input, disposing a second object having the first 3D model in the virtual space, in a pose based on the first pose data.

With the configuration of (1), the second object having the same 3D model as that of the first object can be disposed in the virtual space, in a pose based on the first object at the time of the first command based on the user's operation input. Therefore, the user can enjoy the second object disposed in a pose desired by the user in the virtual space as a novel collection element.

(2) In the configuration of (1), the game processing may further comprise: according to the first command, generating a first image including the first object obtained by imaging at least a portion of the virtual space as viewed from a virtual camera at the time of the first command; and additionally storing the first image into the storage.

With the configuration of (2), the first pose data can be stored together with the first image captured by the imaging, according to the user's operation for capturing an image of at least a portion of the virtual space.

(3) In the configuration of (2), information indicating the first 3D model and the first pose data may be stored into the storage in association with the first image.

With the configuration of (3), the first image captured based on the user's operation input can be used in order to choose the first pose data.

(4) In the configuration of (2) or (3), the game processing may further comprise: displaying a list of images including the first image or images. When one of the first images is designated based on a third command based on an operation input during displaying of the list of images, the second object having the same first 3D model as that of the first object related to the designated first image may be disposed in the virtual space, in a pose based on the first pose data.

With the configuration of (4), the first image can be used in order to choose the second object to be disposed, and the second object to be disposed can be indicated by the image in an easy-to-understand manner.

(5) In the configuration of any one of (1) to (4), the first object may include a plurality of bones used in control of the first 3D model. In this case, the first pose data may include data indicating a state of the plurality of bones at the time of the first command.

With the configuration of (5), the pose of the first object can be easily reflected in the second object by using the state of the bones used in control of the 3D model.

(6) In the configuration of any one of (1) to (5), for the first object, an animation in which an appearance thereof may be changed, depending on a condition, is set. Animation state data related to a state of the animation of the first object at the time of the first command may be additionally stored, into the storage. According to the second command, the second object in the virtual space may be disposed in a pose based on the first pose data and with an appearance based on the animation state data.

With the configuration of (6), the appearance of the first object can also be reflected in the second object.

(7) In the configuration of any one of (1) to (6), the game processing may further comprise: rendering the first object in the virtual space by a first rendering process; and rendering the second object disposed in the virtual space by a second rendering process different from the first rendering process.

With the configuration of (7), the first and second objects can be easily distinguished from each other in the virtual space.

(8) In the configuration of any one of (1) to (7), the game processing may further comprise: moving the second object in the virtual space based on an operation input, with the pose based on the first pose data maintained.

With the configuration of (8), the second object can be disposed at a place matching the user's preference, facing in the desired direction.

(9) In the configuration of any one of (1) to (8), the game processing may further comprise: moving the second object in the virtual space based on an operation input, with local coordinates of the second object at the time of the disposition of the second object in the virtual space fixed.

With the configuration of (9), the second object can be disposed at a place matching the user's preference, facing in the desired direction.

(10) In the configuration of any one of (1) to (9), according to the first command, type data indicating a type of a character related to the first object may be additionally stored, together with the first pose data, into the storage, and according to the second command, a character of a type based on the type data in the virtual space may be disposed in a pose based on the first pose data.

With the configuration of (10), an object based on the type of the first object can be disposed as the second object.

(11) In the configuration of any one of (1) to (10), the first object may be equipped with at least one first equipment object at a part thereof. In this case, according to the first command, equipment data indicating a type of the first equipment object may be additionally stored into the storage, in addition to the first pose data at the time of the first command, and according to the second command, the second object in the virtual space may be disposed in a pose based on the first pose data with a second equipment object related to the equipment data attached to the part of the second object.

With the configuration of (11), the second object can be disposed with the first object's equipment reflected in the second object's equipment.

(12) In the configuration of (11), the game processing may further comprise: controlling a player character in the virtual space based on an operation input; controlling the first object's action of attacking the player character using the first equipment object in the virtual space; and even when the first command is given during the first object's action of attacking, storing, into the storage, the first pose data and the equipment data at the time of the first command.

With the configuration of (12), the second object can be disposed such that a scene in which the first object is attacking is reproduced.

(13) In the configuration of any one of (1) to (12), the game processing may further comprise: setting a polyhedron enclosing the second object. The second object may be disposed in a pose based on the first pose data with one of the surfaces of the polyhedron in contact with a ground in the virtual space.

With the configuration of (13), the second object can be disposed in the virtual space, in a direction based on a shape of the polyhedron.

In addition, the present example may be carried out in the forms of a game system, game apparatus, and game processing method.

According to the present example, a second object that is disposed in the virtual space, in a pose desired by the user, can be enjoyed as a novel collection element.

These and other objects, features, aspects and advantages of the present exemplary embodiment will become more apparent from the following detailed description of the present exemplary embodiment when taken in conjunction with the accompanying drawings.

### BRIEF DESCRIPTION OF THE DRAWINGS

FIG. 1 is a diagram illustrating a non-limiting example of a state in which a left controller 3 and a right controller 4 are attached to a main body apparatus 2,

FIG. 2 is a diagram illustrating a non-limiting example of a state in which a left controller 3 and a right controller 4 are detached from a main body apparatus 2,

FIG. 3 illustrates six orthogonal views of a non-limiting example of a main body apparatus 2,

FIG. 4 illustrates six orthogonal views of a non-limiting example of a left controller 3,

FIG. 5 illustrates six orthogonal views of a non-limiting example of a right controller 4,

FIG. 6 is a block diagram illustrating a non-limiting example of an internal configuration of a main body apparatus 2,

FIG. 7 is a block diagram illustrating non-limiting examples of internal configurations of a main body apparatus 2, a left controller 3, and a right controller 4,

FIG. 8 is a diagram illustrating a non-limiting example of a game image showing a scene in which a player character PC fights with an opponent character EC in a virtual space,

FIG. 9 is a diagram illustrating a non-limiting example of a game image showing a scene in which an image of a virtual space is captured according to an operation command to capture an image of the virtual space,

FIG. 10 is a diagram illustrating a non-limiting example of a game image showing a list of captured images of opponent characters EC (figures F) that can be caused to appear in a virtual space,

FIG. 11 is a diagram illustrating a non-limiting example of a game image showing a scene in which a figure F is caused to appear in a virtual space,

FIG. 12 is a diagram illustrating a non-limiting example of bones B set for an opponent character EC,

FIG. 13 is a diagram illustrating a non-limiting example of a relationship between an opponent character's equipment and a figure's equipment,

FIG. 14 is a diagram illustrating a non-limiting example of figures F1a to F1c that appear, having different appearances,

FIG. 15 is a diagram illustrating a non-limiting example of a game image in which a figure F4 corresponding to an opponent character EC4 that is partially broken appears,

FIG. 16 is a diagram illustrating a non-limiting example of a polyhedron set for a figure F,

FIG. 17 is a diagram illustrating a non-limiting example of a data area set in a DRAM 85 of a main body apparatus 2,

FIG. 18 is a flowchart illustrating a non-limiting example of a game process that is executed in the game system 1,

FIG. 19 is a subroutine illustrating a non-limiting example of a normal game process in step S124 of FIG. 18,

FIG. 20 is a subroutine illustrating a non-limiting example of an imaging mode process in step S146 of FIG. 19, and

FIG. 21 is a subroutine illustrating a non-limiting example of a figure disposition process in step S128 of FIG. 18.

### DETAILED DESCRIPTION OF NON-LIMITING EXAMPLE EMBODIMENTS

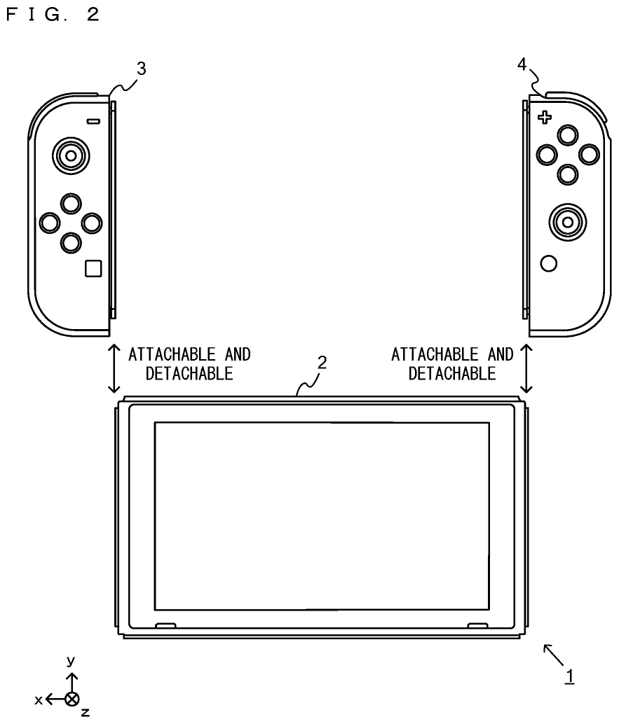

A game system according to the present example will now be described. An example of a game system 1 according to the present example includes a main body apparatus (information processing apparatus serving as the main body of a game apparatus in the present example) 2, a left controller 3, and a right controller 4. The left controller 3 and the right controller 4 are attachable to and detachable from the main body apparatus 2. That is, the user can attach the left controller 3 and the right controller 4 to the main body apparatus 2, and use them as a unified apparatus. The user can also use the main body apparatus 2 and the left controller 3 and the right controller 4 separately from each other (see FIG. 2). In the description that follows, a hardware configuration of the game system 1 of the present example is described, and thereafter, the control of the game system 1 of the present example is described.

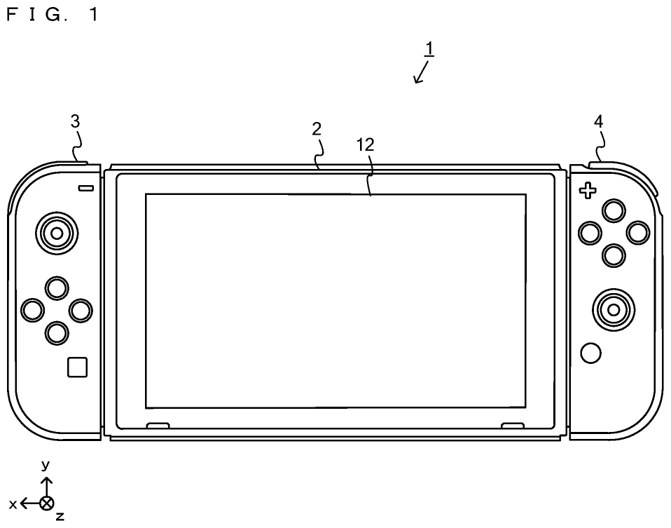

FIG. 1 is a diagram illustrating an example of a state in which the left controller 3 and the right controller 4 are attached to the main body apparatus 2. As illustrated in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram illustrating an example of a state in which each of the left controller 3 and the right controller 4 is detached from the main body apparatus 2. As illustrated in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

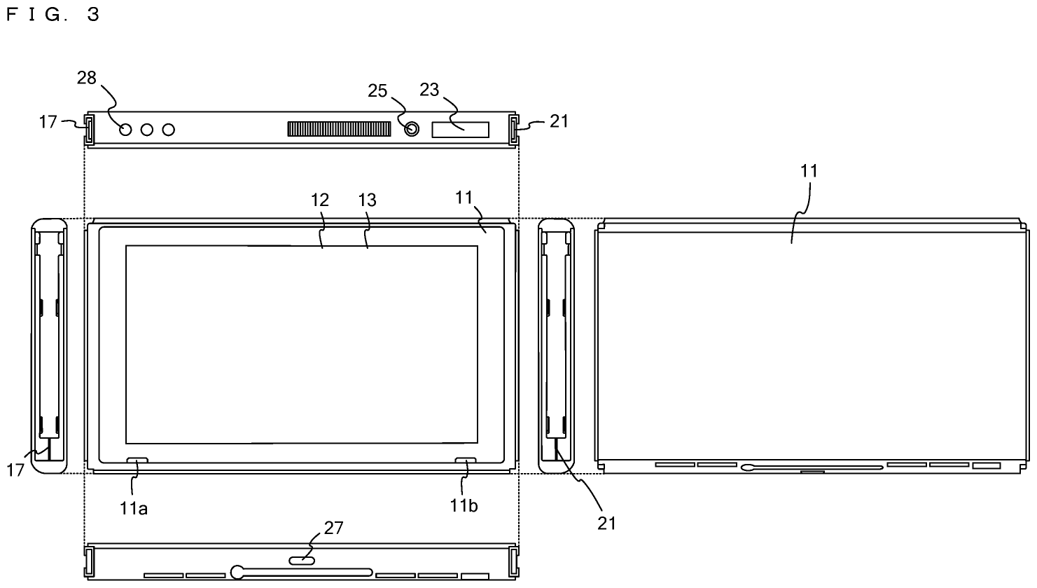

FIG. 3 illustrates six orthogonal views of an example of the main body apparatus 2. As illustrated in FIG. 3, the main body apparatus 2 includes an approximately plate-shaped housing 11. In the present example, a main surface (in other words, a surface on a front side, i.e., a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As illustrated in FIG. 3, the main body apparatus 2 includes the display 12, which is provided on the main surface of the housing 11. The display 12 displays an image generated by the main body apparatus 2. In the present example, the display 12 is a liquid crystal display device (LCD). The display 12, however, may be a display device of any suitable type.

In addition, the main body apparatus 2 includes a touch panel 13 on the screen of the display 12. In the present example, the touch panel 13 allows multi-touch input (e.g., a capacitive touch panel). It should be noted that the touch panel 13 may be of any suitable type, e.g., it allows single-touch input (e.g., a resistive touch panel).

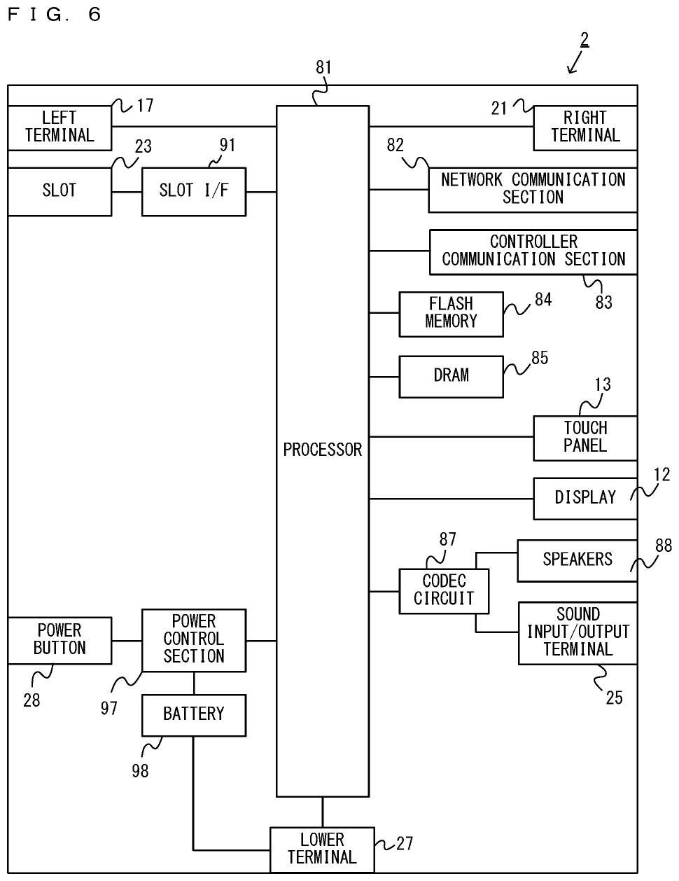

The main body apparatus 2 includes a speaker (i.e., a speaker 88 illustrated in FIG. 6) inside the housing 11. As illustrated in FIG. 3, speaker holes 11a and 11b are formed in the main surface of the housing 11. The speaker 88 outputs sounds through the speaker holes 11a and 11b.

The main body apparatus 2 also includes a left-side terminal 17 that enables wired communication between the main body apparatus 2 and the left controller 3, and a right-side terminal 21 that enables wired communication between the main body apparatus 2 and the right controller 4.

As illustrated in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower-side terminal 27. The lower-side terminal 27 allows the main body apparatus 2 to communicate with a cradle. In the present example, the lower-side terminal 27 is a USB connector (more specifically, a female connector). When the unified apparatus or the main body apparatus 2 alone is placed on the cradle, the game system 1 can display, on a stationary monitor, an image that is generated and output by the main body apparatus 2. Also, in the present example, the cradle has the function of charging the unified apparatus or the main body apparatus 2 alone, being placed thereon. The cradle also functions as a hub device (specifically, a USB hub).

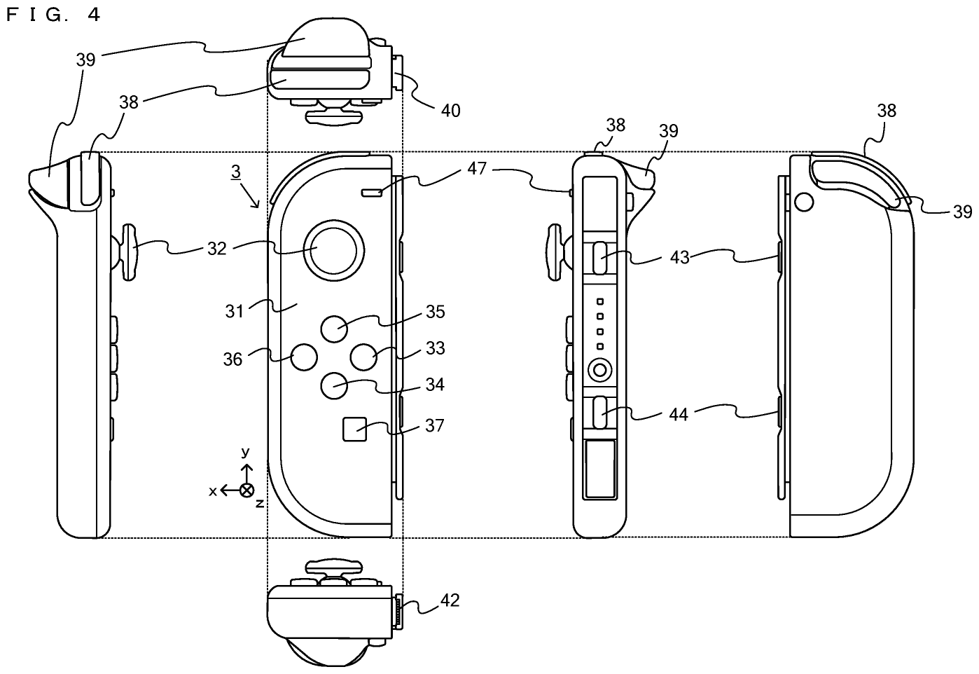

FIG. 4 illustrates six orthogonal views of an example of the left controller 3. As illustrated in FIG. 4, the left controller 3 includes a housing 31. In the present example, the housing 31 has a vertically long shape, e.g., is shaped to be long in an up-down direction (i.e., a y-axis direction illustrated in FIGS. 1 and 4). In the state in which the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As illustrated in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the present example, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “—” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give commands depending on various programs (e.g., an OS program and an application program) executed by the main body apparatus 2.

The left controller 3 also includes a terminal 42 that enables wired communication between the left controller 3 and the main body apparatus 2.

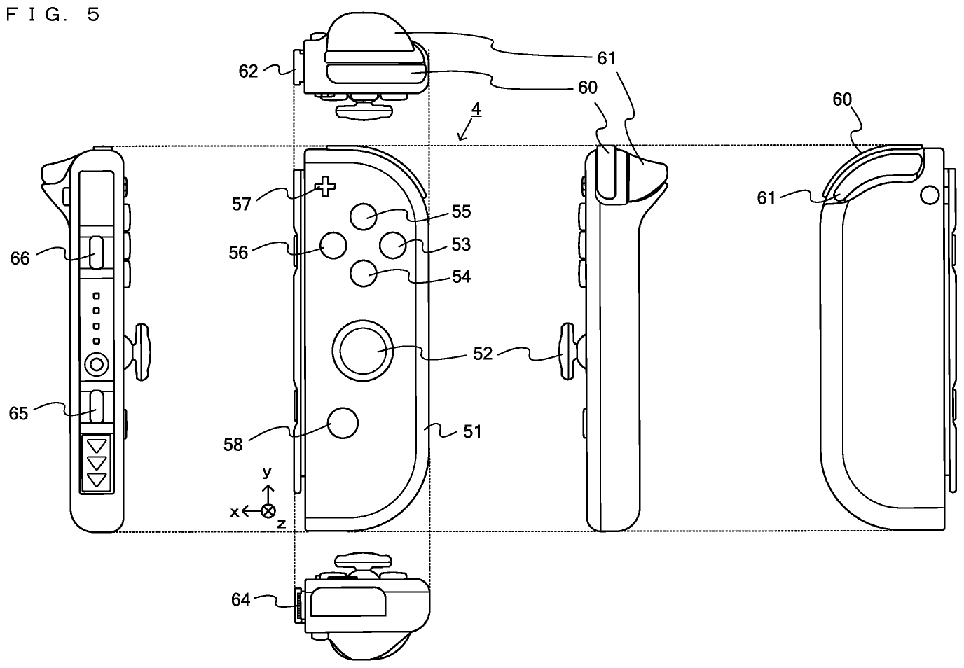

FIG. 5 illustrates six orthogonal views of an example of the right controller 4. As illustrated in FIG. 5, the right controller 4 includes a housing 51. In the present example, the housing 51 has a vertically long shape, e.g., is shaped to be long in the up-down direction. In the state in which the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the present example, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for allowing the right controller 4 to perform wired communication with the main body apparatus 2.

FIG. 6 is a block diagram illustrating an example of an internal configuration of the main body apparatus 2. The main body apparatus 2 includes components 81 to 91, 97, and 98 illustrated in FIG. 6 in addition to the components illustrated in FIG. 3. Some of the components 81 to 91, 97, and 98 may be implemented as electronic parts on an electronic circuit board, which is contained in the housing 11.

The main body apparatus 2 includes a processor 81. The processor 81 is an information processor for executing various types of information processing to be executed by the main body apparatus 2. For example, the CPU 81 may include only a central processing unit (CPU), or may be a system-on-a-chip (SoC) having a plurality of functions such as a CPU function and a graphics processing unit (GPU) function. The processor 81 executes an information processing program (e.g., a game program) stored in a storage section (specifically, an internal storage medium such as a flash memory 84, an external storage medium that is attached to the slot 23, or the like), thereby executing the various types of information processing.

The main body apparatus 2 includes a flash memory 84 and a dynamic random access memory (DRAM) 85 as examples of internal storage media built in itself. The flash memory 84 and the DRAM 85 are connected to the CPU 81. The flash memory 84 is mainly used to store various data (or programs) to be saved in the main body apparatus 2. The DRAM 85 is used to temporarily store various data used in information processing.

The main body apparatus 2 includes a slot interface (hereinafter abbreviated to “I/F”) 91. The slot I/F 91 is connected to the processor 81. The slot I/F 91 is connected to the slot 23, and reads and writes data from and to a predetermined type of storage medium (e.g., a dedicated memory card) attached to the slot 23, in accordance with commands from the processor 81.

The processor 81 reads and writes, as appropriate, data from and to the flash memory 84, the DRAM 85, and each of the above storage media, thereby executing the above information processing.

The main body apparatus 2 includes a network communication section 82. The network communication section 82 is connected to the processor 81. The network communication section 82 communicates (specifically, through wireless communication) with an external apparatus via a network. In the present example, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a particular protocol or infrared light communication). It should be noted that the wireless communication in the above second communication form achieves the function of allowing so-called “local communication”, in which the main body apparatus 2 can wirelessly communicate with another main body apparatus 2 located in a closed local network area, and the plurality of main body apparatuses 2 directly communicate with each other to exchange data.

The main body apparatus 2 includes a controller communication section 83. The controller communication section 83 is connected to the processor 81. The controller communication section 83 wirelessly communicates with the left controller 3 and/or the right controller 4. The main body apparatus 2 may communicate with the left and right controllers 3 and 4 using any suitable communication method. In the present example, the controller communication section 83 performs communication with the left and right controllers 3 and 4 in accordance with the Bluetooth (registered trademark) standard.

The processor 81 is connected to the left-side terminal 17, the right-side terminal 21, and the lower-side terminal 27. When performing wired communication with the left controller 3, the processor 81 transmits data to the left controller 3 via the left-side terminal 17 and also receives operation data from the left controller 3 via the left-side terminal 17. Further, when performing wired communication with the right controller 4, the processor 81 transmits data to the right controller 4 via the right-side terminal 21 and also receives operation data from the right controller 4 via the right-side terminal 21. Further, when communicating with the cradle, the processor 81 transmits data to the cradle via the lower-side terminal 27. As described above, in the present example, the main body apparatus 2 can perform both wired communication and wireless communication with each of the left and right controllers 3 and 4. Further, when the unified apparatus obtained by attaching the left and right controllers 3 and 4 to the main body apparatus 2 or the main body apparatus 2 alone is attached to the cradle, the main body apparatus 2 can output data (e.g., image data or sound data) to a stationary monitor or the like via the cradle.

Here, the main body apparatus 2 can communicate with a plurality of left controllers 3 simultaneously (or in parallel). Further, the main body apparatus 2 can communicate with a plurality of right controllers 4 simultaneously (or in parallel). Thus, a plurality of users can simultaneously provide inputs to the main body apparatus 2, each using a set of left and right controllers 3 and 4. As an example, a first user can provide an input to the main body apparatus 2 using a first set of left and right controllers 3 and 4, and at the same time, a second user can provide an input to the main body apparatus 2 using a second set of left and right controllers 3 and 4.

Further, the display 12 is connected to the processor 81. The processor 81 displays, on the display 12, a generated image (e.g., an image generated by executing the above information processing) and/or an externally obtained image.

The main body apparatus 2 includes a codec circuit 87 and speakers (specifically, a left speaker and a right speaker) 88. The codec circuit 87 is connected to the speakers 88 and an audio input/output terminal 25 and also connected to the processor 81. The codec circuit 87 is for controlling the input and output of audio data to and from the speakers 88 and the sound input/output terminal 25.

The main body apparatus 2 includes a power control section 97 and a battery 98. The power control section 97 is connected to the battery 98 and the processor 81. Further, although not illustrated, the power control section 97 is connected to components of the main body apparatus 2 (specifically, components that receive power supplied from the battery 98, the left-side terminal 17, and the right-side terminal 21). Based on a command from the processor 81, the power control section 97 controls the supply of power from the battery 98 to each of the above components.

Further, the battery 98 is connected to the lower-side terminal 27. When an external charging device (e.g., the cradle) is connected to the lower-side terminal 27, and power is supplied to the main body apparatus 2 via the lower-side terminal 27, the battery 98 is charged with the supplied power.

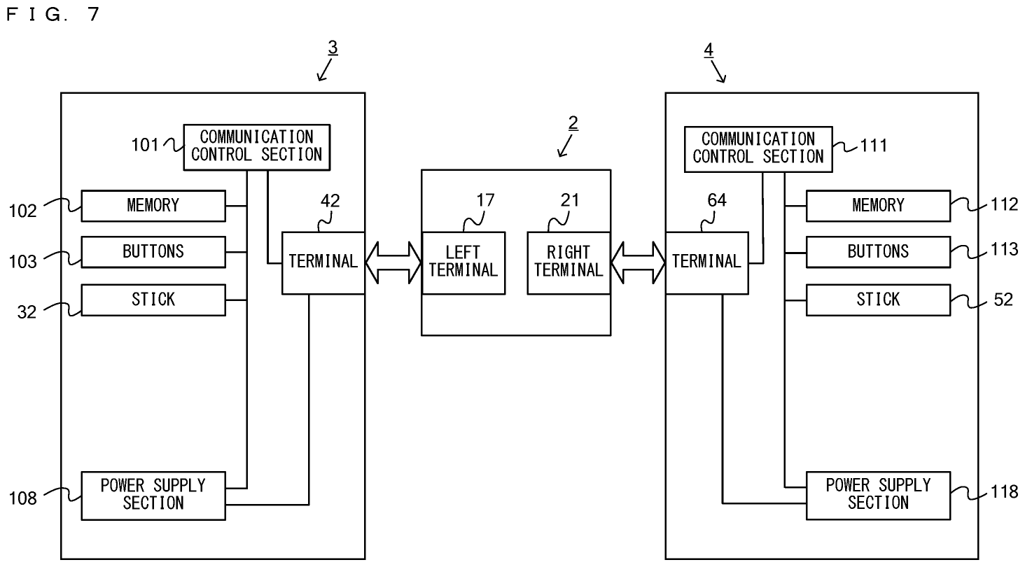

FIG. 7 is a block diagram illustrating examples of the internal configurations of the main body apparatus 2, the left controller 3, and the right controller 4. It should be noted that the details of the internal configuration of the main body apparatus 2 are illustrated in FIG. 6 and therefore are omitted in FIG. 7.

The left controller 3 includes a communication control section 101, which communicates with the main body apparatus 2. As illustrated in FIG. 7, the communication control section 101 is connected to components including the terminal 42. In the present example, the communication control section 101 can communicate with the main body apparatus 2 through both wired communication via the terminal 42 and wireless communication without via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing. The communication control section 101 obtains information regarding an input (specifically, information regarding an operation or the detection result of the sensor) from each of input sections (specifically, the buttons 103 and the analog stick 32). The communication control section 101 transmits operation data including the obtained information (or information obtained by performing predetermined processing on the obtained information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the present example, the power supply section 108 includes a battery and a power control circuit. Although not illustrated in FIG. 7, the power control circuit is connected to the battery and also connected to components of the left controller 3 (specifically, components that receive power supplied from the battery).

As illustrated in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, a communication control section 111 can communicate with the main body apparatus 2 through both wired communication via the terminal 64 and wireless communication without via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

As described above, in the game system 1 of the present example, the left controller 3 and the right controller 4 are removable from the main body apparatus 2. In addition, when the unified apparatus obtained by attaching the left controller 3 and the right controller 4 to the main body apparatus 2 or the main body apparatus 2 alone is attached to the cradle, an image (and sound) can be output on an external display device, such as a stationary monitor or the like. The game system 1 will be described below according to an embodiment in which an image is displayed on the display 12. It should be noted that in the case in which the game system 1 is used in an embodiment in which an image is displayed on the display 12, the game system 1 may be used with the left controller 3 and the right controller 4 attached to the main body apparatus 2 (e.g., the main body apparatus 2, the left controller 3, and the right controller 4 are integrated in a single housing).

A game is played using a virtual space displayed on the display 12, according to operations performed on the operation buttons and sticks of the left controller 3 and/or the right controller 4, or touch operations performed on the touch panel 13 of the main body apparatus 2, in the game system 1. In the present example, as an example, a game can be played using a player character PC that performs an action in a virtual space according to the user's operation performed using the operation buttons, the sticks, and the touch panel 13.

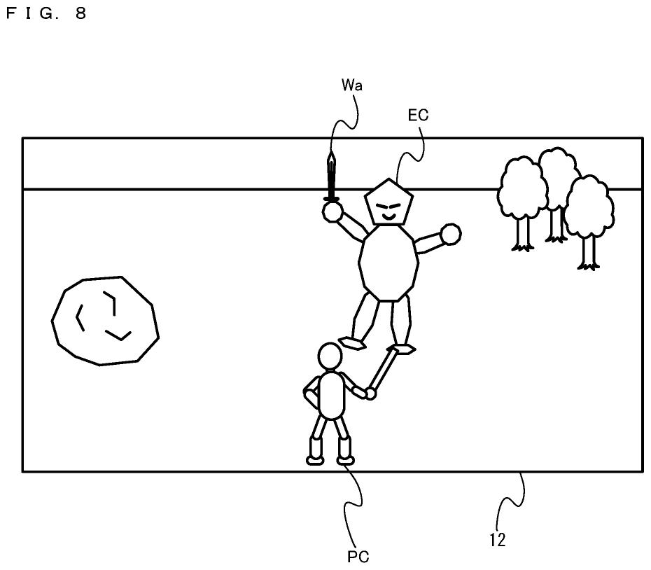

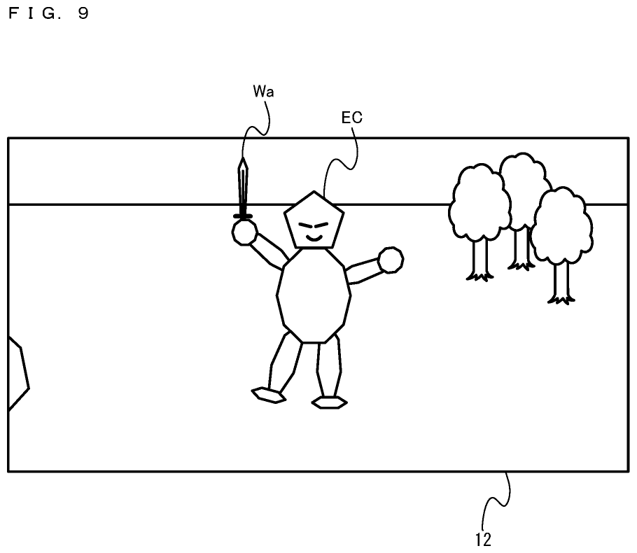

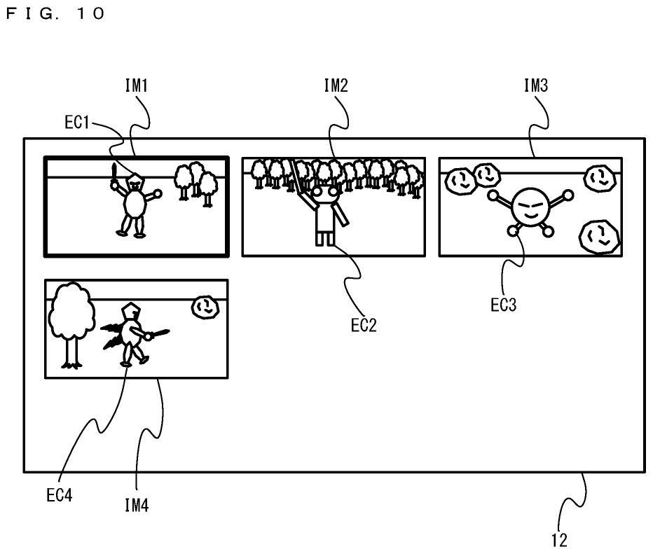

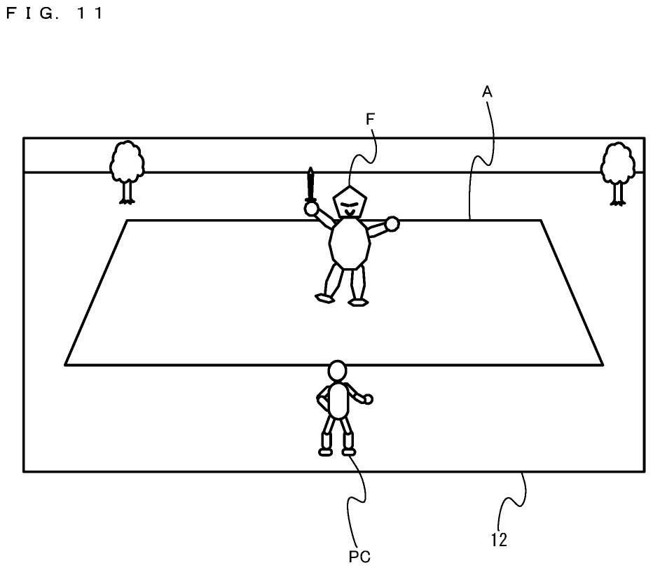

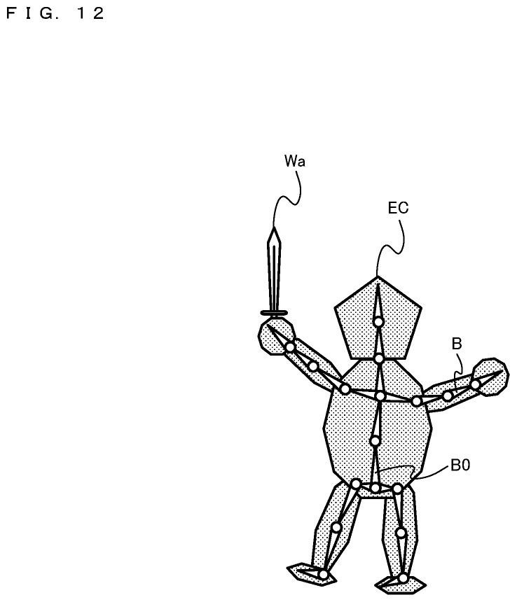

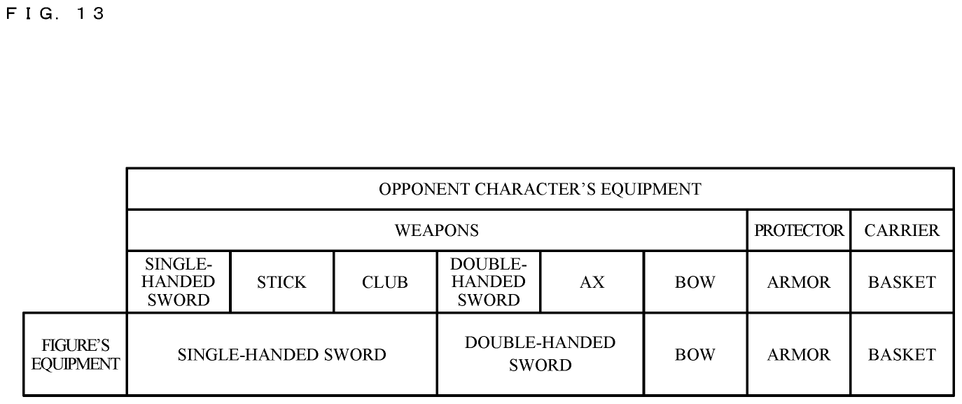

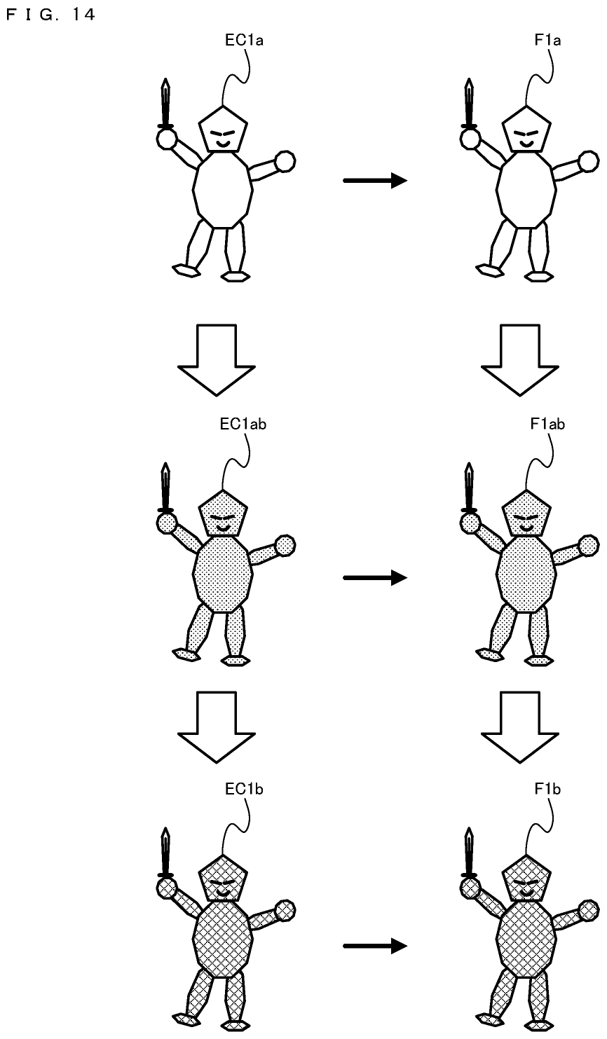

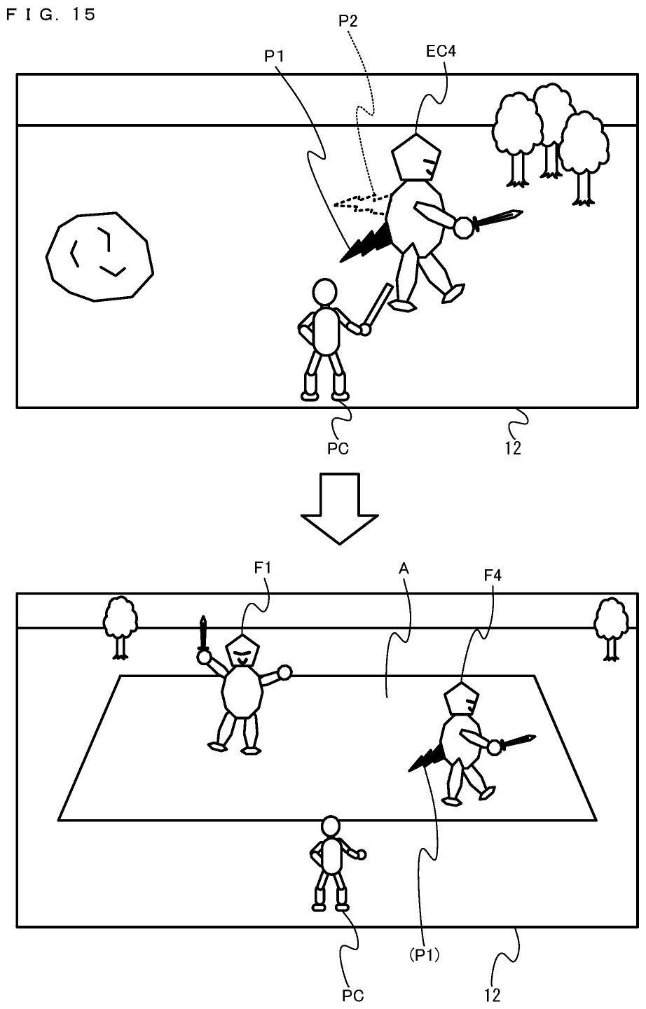

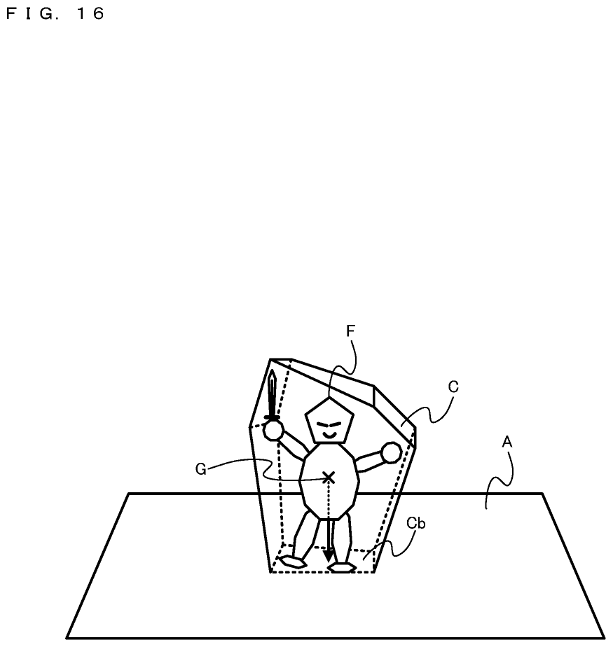

A game process that is executed in the game system 1 will be outlined with reference to FIGS. 8 to 16. It should be noted that FIG. 8 is a diagram illustrating an example of a game image showing a scene in which a player character PC fights with an opponent character EC in a virtual space. FIG. 9 is a diagram illustrating an example of a game image showing a scene in which an image of a virtual space is captured according to an operation command to capture an image of the virtual space. FIG. 10 is a diagram illustrating an example of a game image showing a list of captured images of opponent characters EC (figures F) that can be caused to appear in a virtual space. FIG. 11 is a diagram illustrating an example of a game image showing a scene in which a figure F is caused to appear in a virtual space. FIG. 12 is a diagram illustrating an example of bones B set for an opponent character EC. FIG. 13 is a diagram illustrating an example of a relationship between an opponent character's equipment and a figure's equipment. FIG. 14 is a diagram illustrating an example of figures F1a to F1c that appear, having different appearances. FIG. 15 is a diagram illustrating an example of a game image in which a figure F4 corresponding to an opponent character EC4 that is partially broken appears. FIG. 16 is a diagram illustrating an example of a polyhedron set for a figure F. In FIG. 8, a game image is displayed in which a player character PC and an opponent character EC are disposed in a virtual space. The player character PC performs an action in the virtual space based on the user's movement operation input. In addition, a plurality of opponent characters EC are disposed in the virtual space. Each opponent character EC's action is automatically controlled by the processor 81. Although in the present example a game image is displayed on the display 12 of the main body apparatus 2, a game image may be displayed on other display devices connected to the main body apparatus 2.

The player character PC can perform an action of attacking an opponent character EC according to the user's operation. As an example, control can be performed such that the player character PC performs an attack action using a weapon object according to the user's operation.

In addition, opponent characters EC can also perform an action of attacking the player character PC by the automatic control. As an example, an opponent character EC can perform an attack action using a weapon object with which the opponent character EC is equipped. In the present example, as a weapon object with which an opponent character EC can be equipped, a weapon object that can be handled with a single hand of the opponent character EC, a weapon object that can be handled with both hands of the opponent character EC, a weapon object that can be used in a long-range attack by the opponent character EC, and the like are prepared. The weapon object that can be handled with a single hand of an opponent character EC is, for example, a single-handed sword Wa illustrated in FIG. 8, or in addition, a stick, a club, or the like. The weapon object that can be handled with both hands of an opponent character EC is, for example, a double-handed sword, an ax, or the like. The weapon object that can be used in a long-range attack by an opponent character EC is, for example, a bow and an arrow, or the like. In the present example, an opponent character EC can be equipped with one of the prepared weapon objects and use the one weapon object in an attack action. In addition, even when an opponent character EC is not equipped with any of the above weapon objects, the opponent character EC can perform an attack action using its own body (e.g., an arm or a foot).

In addition, an opponent character EC can be equipped with, in addition to the above weapon objects, a protective object such as an armor that protects itself against attacks from other characters such as the player character PC, and a carrier object such as a basket that carries an item. In the present example, an opponent character EC can be equipped with a protective object or carrier object together with the weapon object.

It should be noted that an opponent character EC may be allowed to be equipped with an equipment object disposed on a field in the virtual space. In that case, the player character PC may put an equipment object that the player character PC desires that an opponent character EC should be equipped with, in the vicinity of the opponent character EC, so that the opponent character EC may be equipped with the equipment object. Thus, an opponent character EC can be equipped with an equipment object desired by the user.

In addition, in another example, an opponent character EC may be equipped with a plurality of weapon objects and use the weapons in an attack action. In that case, an opponent character EC may be allowed to be equipped with the plurality of weapon objects together with a protective object or a carrier object.

In the present example, an image of a landscape in the virtual space as viewed from the player character PC can be stored as a collection element of the user. For example, as illustrated in FIG. 9, the player character PC starts an action of capturing an image of the virtual space using a camera according to the user's operation input for switching to an imaging mode, so that a game image is switched to a range of view of the virtual space as viewed by the player character PC through the camera. The player character PC can also move and change its orientation in the virtual space in the imaging mode according to the user's movement operation input, and the range of view can be moved according to a change in the movement or orientation.

In the imaging mode, when the user performs an imaging operation input, a captured image showing a range of the virtual space (i.e., the range of view) that is displayed at the time of the operation input is stored as the user's collection element into a storage medium (e.g., the DRAM 85). When an opponent character EC is included in the captured image, figure generation data that is used to cause a figure F corresponding to the opponent character EC to appear in the virtual space is stored into the storage medium in association with the captured image. Here, the figure F is an object that has the same 3D model as that of the opponent character EC, and is disposed in the virtual space, adopting the same pose and appearance as those of the opponent character EC at the time of the imaging. Although a figure F is typically an object that has the same appearance as that of an imaged opponent character, the appearance may be partially different, depending on the state, type, equipment or the like of the opponent character EC. It should be noted that the details of a figure F and figure generation data for generating a figure F will be described below.

In the present example, when a plurality of opponent characters EC are included in the captured image, a representative one of the plurality of opponent characters EC is designated as one for which a figure F is to be generated, and figure generation data for the representative opponent character EC is stored. For example, one of the opponent characters EC that is closest to the virtual camera may be designated as one for which a figure F is to be generated. Alternatively, one of the opponent characters EC that is closest to the center of the captured image may be designated as one for which a figure F is to be generated. Alternatively, one of the opponent characters EC that has a largest area in the captured image may be designated as one for which a figure F is to be generated. Alternatively, one of the opponent characters EC that satisfies two or more of these conditions may be designated as one for which a figure F is to be generated.

The user is allowed to transition to the imaging mode in various situations including the player character PC's fighting with an opponent character EC, and store a captured image of the opponent character EC as a subject, as a collection element. Therefore, even when an opponent character EC is attacking the player character PC, the user is allowed to transition to the imaging mode and capture an image of the virtual space, and thereby store the attacking opponent character EC as a collection element.

The user is allowed to store a plurality of pairs of a captured image and figure generation data associated with the captured image. As illustrated in FIG. 10, the plurality of pairs of a captured image and figure generation data stored can be checked when a list of captured images (list image) is displayed according to the user's operation command. In the example of FIG. 10, a captured image IM1 of an opponent character EC1 associated with figure generation data, a captured image IM2 of an opponent character EC2 associated with figure generation data, a captured image IM3 of an opponent character EC3 associated with figure generation data, and a captured image IM4 of an opponent character EC4 associated with figure generation data are displayed in the form of a list. It should be noted that the number of pairs of a captured image and figure generation data that can be stored may be limited.

As illustrated in FIG. 11, based on the user's operation input that designates one of the captured images when a list of the captured images is being displayed, a figure F having the same 3D model as that of an opponent character EC included in the designated captured image appears in the virtual space, adopting a pose based on figure generation data associated with the captured image. Here, as described below, figure generation data includes information about the type of a figure F that is caused to appear, corresponding to an imaged opponent character EC, information about the pose and appearance of the opponent character EC at the time of imaging, and the like. The figure F based on the information appears in the virtual space. In the example of FIG. 11, the captured image of the opponent character EC illustrated in FIG. 9 is designated, and a figure F having the same 3D model as that of the opponent character EC appears in the virtual space, adopting the same pose and appearance as those of the imaged opponent character EC. Thus, in the present example, not only a captured image but also a figure F having the same 3D model as that of an opponent character EC as a subject in the captured image can be caused to appear as a novel collection element in the virtual space.

When one is chosen from a list of captured images, a figure F corresponding to the chosen captured image appears at a predetermined appearing location set in the virtual space. For example, the appearing location may be in the vicinity of the player character PC or within a predetermined range (e.g., a range A illustrated in FIG. 11) set in the virtual space. As described below, the user is allowed to move a figure F that has once appeared in the virtual space. The destination of the figure F may be limited to the above appearing location.

In addition, the number of figures F appearing in the virtual space may be limited. When the user gives a command to cause more figures F than the limited number to appear in the virtual space, the user may be prompted to perform an operation of deleting some of figures F that have already appeared, or the figure F that has appeared first may be automatically deleted. By thus limiting the number of figures F appearing in the virtual space, the processing load involved with the appearing of figures F can be reduced.

Next, figure generation data stored in association with a captured image will be described. The figure generation data contains data (bone data) indicating a state of a plurality of bones set for an opponent character EC or a figure F as pose data corresponding to the pose that the opponent character EC adopts at the time of capturing the image.

For example, as illustrated in FIG. 12, an opponent character EC includes a plurality of bones B that are used in control of a 3D model. The bones B are used to determine a shape of the opponent character EC. A surface of the opponent character EC is formed so as to surround the plurality of bones B. By moving or deforming each of the plurality of bones B, the entire opponent character EC is caused to move or deform. For example, for each of the plurality of constituent bones B, a bone that is set immediately above that bone B is referred to as a master bone. When a master bone is moved, rotated, or enlarged/reduced, a slave bone set below the master bone is similarly moved, rotated, or enlarged/reduced, so that the entire opponent character EC is moved or deformed.

A bone B includes a head at which the bone B is connected to a master bone, a tail at which the bone B is connected to a slave bone, and a body that links the head and the tail. The bone data included in the figure generation data indicates a location and a direction of each bone B in a local coordinate system of the opponent character EC. As an example, the bone data includes relative locations and orientations from a master bone to a slave bone (e.g., locations and directions of the head, tail, and body of a slave bone), which are disposed in order from the master bone to the slave bone, where a basic bone BO is the origin of a local coordinate system.

In the present example, when an image of an opponent character EC as a subject is captured, the bone data of a plurality of bones B included in the imaged opponent character EC is obtained, and is stored together with the captured image as a portion of the figure generation data. When a figure F having the same 3D model as that of the opponent character EC is created, the figure F has the same bone configuration as that based on the bone data obtained and stored for the opponent character EC and is caused to appear in the virtual space. As a result, the figure F having the same 3D model as that of the opponent character EC is an object having the same bone configuration as that of the opponent character EC, and appears in the virtual space, maintaining the same pose that the opponent character EC adopts.

Concerning an equipment object (e.g., the single-handed sword Wa illustrated in FIG. 12) of an opponent character EC, if, when a part of the opponent character EC to which the equipment object is to be attached is determined, the orientation and location of the equipment object are determined, the type of the equipment object of the opponent character EC and the part to which the equipment object is attached are stored as a portion of the figure generation data. As a result, for a figure F having the same 3D model as that of the opponent character EC, the same equipment object can be disposed at the same orientation and location as those of the opponent character EC by disposing the same equipment object at the same part as that of the opponent character EC. In another example, in addition to the type of the equipment object of the opponent character EC and the part to which the equipment object is attached, data indicating the orientation of the equipment object may be stored as a portion of the figure generation data. For example, when the equipment object itself is deformed or moved, so that the orientation and location of the equipment object are not determined only based on the part of the opponent character EC to which the equipment object is attached, a figure F in which the state of the equipment object with which the opponent character EC is equipped is correctly copied can be caused to appear by using data indicating the orientation of the equipment object at the time of capturing an image of the opponent character EC.

Although in the foregoing example an equipment object of a figure F is the same as that of an opponent character EC, an equipment object of a figure F may be different from that of an opponent character EC. For example, as illustrated in FIG. 13, when an opponent character EC can be equipped with multiple equipment objects, a figure F may appear, being equipped with a representative one of the equipment objects. As an example, when an opponent character EC can be equipped with a single-handed sword, a stick, a club, and the like as a weapon object that can be handled with a single hand of the opponent character EC, a figure F appears, being equipped with the single-handed sword as the representative weapon object, no matter which of the weapon objects the opponent character EC is equipped with. In addition, when an opponent character EC can be equipped with a double-handed sword, an ax, and the like as a weapon object that can be handled with both hands of the opponent character EC, a figure F appears, being equipped with the double-handed sword as the representative weapon object, no matter which of the weapon objects the opponent character EC is equipped with. By thus narrowing and limiting the types of equipment objects with which an opponent character EC can be equipped, the load of the process of generating a figure F can be reduced.

In addition, the figure generation data of the present example includes data (type data) for setting the type of a figure F that is to appear, corresponding to an imaged opponent character EC. The type data is for reconstructing an imaged opponent character EC as a figure F, and includes 3D model data indicating a basic bone configuration, 3D mesh, texture, and the like for generating an object, or data that can be used to obtain the 3D model data. The type data may be data indicating the type of an imaged opponent character EC, i.e., data that can be used to obtain the 3D model data of the opponent character EC, or data indicating the type of a figure F that is to appear, i.e., data that can be used to obtain the 3D model data of the figure F.

It should be noted that the type of an equipment object of an opponent character EC that is imaged for causing a figure F to appear and a part of the opponent character EC to which the equipment object is attached may be previously set as fixed data for each type of equipment associated with the type data of the figure F, instead of being stored as a portion of the figure generation data. In that case, a part of an opponent character EC to which an equipment object is attached is not stored at the time of imaging, the fixed data for each type of equipment is previously stored in association with the type data of a figure F, and at the time of imaging it is determined whether or not the opponent character EC is equipped with an equipment object. When an opponent character EC is equipped with an equipment object, a figure F is generated with reference to the fixed data for each type of equipment associated with the type data of the figure F, and is caused to appear, being equipped with an equipment object (e.g., the same equipment object or a representative one of equipment objects) based on the equipment object with which the opponent character EC is equipped.

In the present example, the type of an imaged opponent character EC may be the same as the type of a figure F that appears, corresponding to the opponent character EC, or may be similar to, but not exactly the same as, the type of a figure F that appears, corresponding to the opponent character EC. For example, when an opponent character EC is classified as one of relatively numerous sub-types, a representative one of the sub-types may be set as the type of a figure F. For example, when the type of an opponent character EC can be chosen from a standard type ogre E0, a special type-A ogre EA, a special type-B ogre EB, a special type-C ogre EC, and the like that are obtained by subdividing the type “ogre” of opponents, the type of a figure F may be set to the standard type ogre E0, which is the representative type of “ogre”, no matter which type of “ogre” the opponent character EC is set to.

In addition, the figure generation data of the present example includes data (animation data) indicating an animated state of an opponent character EC as appearance control data indicating an appearance of an opponent character EC at the time of capturing an image. For example, when the appearance of an opponent character EC1 is changed by animation in the virtual space, animation data corresponding to a state (e.g., a material state) of the appearance at the time of capturing an image is stored as a portion of the figure generation data.

As illustrated in FIG. 14, it is assumed that the appearance of the opponent character EC1 is changed due to animation from a state of an opponent character EC1a that is an initial state before an appearance change, through a state of an opponent character EC lab that is an intermediate state of the appearance change, to a state of an opponent character EC1b that is a final state of the appearance change. For example, the animation includes a plurality of still images (frames), and the appearance change is represented by playing back the frames in sequence. In that case, in the present example, data indicating frames of animation that are being played back at the time of imaging the opponent character EC1 is stored as animation data.

It should be noted that in the present example, the appearance change of an opponent character EC due to animation may proceed only based on elapsed time in the virtual space. Alternatively, in another example, the appearance change of an opponent character EC due to animation may proceed based on changes in a surrounding environment such as ambient temperature or weather in the virtual space, or changes due to fight or contact with other characters, explosion or discoloration of the opponent character EC itself, or the like.

When a figure F1 corresponding to the opponent character EC1 is caused to appear, the frames of the same animation indicated by the stored animation data are played back to reproduce a state of an appearance of the figure F1 in the frames. As an example, when a surface of the figure F1 is rendered by a shader, the same appearance as that of the opponent character EC1 is reproduced for the figure F1 by applying the same parameters as those of the appearance state of the frames to the shader. By thus applying animation data at the time of capturing an image of the opponent character EC1 to the figure F1, the figure Fla having the same appearance change initial state as that of the opponent character EC1a appears, then the figure Flab having the same appearance change intermediate state as that of the opponent character EC lab appears, and then the figure F1b having the same appearance change final state as that of the opponent character EC1b appears.

Although in the foregoing description the animation data is used as the appearance control data indicating the appearance of an opponent character EC, data indicating other parameters may be stored as the appearance control data. For example, a parameter itself of a shader applied to an opponent character EC may be stored as the appearance control data, or the type of texture applied to an opponent character EC may be stored as the appearance control data. As an example of the latter, the type of texture applied to an opponent character EC may be changed, depending on a surrounding environment (e.g., the type of a terrain on which the opponent character EC is disposed, ambient temperature, or weather) or the like in the virtual space. As an example, when a figure F corresponding to such an opponent character EC is caused to appear, data indicating the type of texture of the opponent character EC applied at the time of imaging may be stored as the appearance control data, and a figure F to which the same texture is applied may be caused to appear. In that case, a figure F to which texture based on an environment around a place where the opponent character EC is imaged is applied is caused to appear irrespective of an environment around a place where the figure F appears. As another example, when an opponent character EC to which texture that changes depending on the surrounding environment is applied is imaged, information indicating that this type of texture is applied is stored as the appearance control data, and when a figure F corresponding to the type of the opponent character EC is caused to appear, a figure F to which texture corresponding to an environment around a place where the figure F appears or the like is applied may be caused to appear. In that case, a figure F to which texture based on an environment around a place where the figure F appears is applied is caused to appear irrespective of an environment around a place where the opponent character EC is imaged.

In addition, in the present example, a size of a figure F that appears, corresponding to an opponent character EC in the virtual space, may not be the same as that of the opponent character EC, i.e., may not be made to scale. A figure F that is reduced by a predetermined scale factor compared to an opponent character EC may be caused to appear, or a figure F that is enlarged by a predetermined scale factor compared to an opponent character EC may be caused to appear. In either case, size data indicating a scale factor that is used at the time of causing a figure F to appear is previously stored in association with the type data of the figure F. Furthermore, an equipment object of the opponent character EC may be enlarged/reduced by the same scale factor. In that case, data of the equipment object of the opponent character EC indicating the scale factor that is used to enlarge/reduce the equipment object, which is to appear as an equipment object of the figure F, may be stored as a portion of the size data.

It should be noted that the figure generation data of the present example may include part state data indicating the presence or absence or state of a part of an opponent character EC at the time of capturing an image. For example, in the present example, an opponent character EC may be partially broken or deformed in the virtual space, and part state data indicating the presence or absence or state of the portion may be stored as a portion of the figure generation data.

For example, as illustrated in FIG. 15, an opponent character EC4 originally has parts P1 and P2 that project from the back thereof. The opponent character EC4 has lost the part P2 due to an influence of fight or contact with another character, a change in a surrounding environment, or the like (in FIG. 15, the loss is indicated by a dashed line). When a captured image of the opponent character EC4 that has lost the part P2 is stored, part state data indicating that the part P2 has been lost at the time of imaging is stored as a portion of the figure generation data.

When a figure F4 corresponding to the opponent character EC4 that has lost the part P2 is caused to appear, the part state of the opponent character EC4 is reproduced in the appearing figure F4 such that the part state indicated by the stored part state data is reflected in the figure F4. As an example, as illustrated in FIG. 15, the figure F4 corresponding to the opponent character EC4 that has lost the part P2 is caused to appear with an appearance in which only a part corresponding to the part P1 projects from the back of the figure F4, i.e., the state in which the part P2 has been lost is reflected, based on the part state data.

As illustrated in FIG. 16, a polyhedron C that encloses a figure F which is based on the figure generation data is set with a plane Cb included in the polyhedron C in contact with a ground in the virtual space, such that the figure F is disposed, standing in a range A in the virtual space.

For example, when the figure F is caused to appear, the polyhedron C is set as a collision detection shape (collision) that encloses a plurality of bones B included in the figure F. The bottom surface (the plane Cb) of the polyhedron C is set such that the figure F stands, in the range A of the virtual space, in the same pose that the opponent character EC in the captured image adopts. Typically, the plane Cb horizontally extends in the virtual space when the figure F is disposed in the above pose, and is formed such that the barycenter of the figure F is disposed in a directly upward direction thereof (i.e., the plane Cb is disposed in the gravity direction of the barycenter G in the virtual space). As a result, when the polyhedron C is disposed such that the plane Cb is in contact with a ground in the virtual space, the figure F enclosed by the polyhedron C is disposed, standing in the same pose that the imaged opponent character EC adopts. In addition, compared to the case in which collision detection is provided at a foot portion of the figure F, when the figure F is standing, the bottom surface (the plane Cb) of the polyhedron C is a portion where collision detection is provided, and therefore, the figure F is less likely to fall. It is considered that, for example, in the case in which collision detection is provided at a foot portion of the figure F, when the figure F adopts some poses, the figure F has a difficulty in adopting a standing pose. When the polyhedron C has a collision detection shape, the figure F can be inhibited from falling.

It should be noted that the polyhedron C may be set for an opponent character EC when the opponent character EC is imaged. In that case, information about the polyhedron C set for the opponent character EC may be stored as a portion of character generation data, and a polyhedron C for a figure F may be set based on the information included in the character generation data when the figure F is caused to appear.

After appearing in the virtual space, a figure F cannot perform an action on its own. Specifically, after appearing in the virtual space, a figure F is disposed in the virtual space, maintaining the pose and appearance based on the figure generation data used at the time of appearing. As a result, the figure F is disposed in the virtual space with the local coordinates of each part of the figure F at the time of appearing in the virtual space fixed.

In the present example, after a figure F is caused to appear in the virtual space, the figure F may be allowed to move in the virtual space according to the user's operation input. As an example, a figure F that has appeared can be caused to move in the range A of the virtual space according to the user's operation input. In the movement, the location of the figure F may be moved, and the direction of the figure F may be rotated around its roll, pitch, and yaw axes. It should be noted that even when a figure F is moved, the pose and appearance thereof based on the figure generation data used at the time of appearing are maintained, and the local coordinates of each part of the figure F are fixed, and therefore, the figure F is moved with the pose and appearance thereof fixed. As a result, a figure F can be moved to any location in the virtual space, and therefore, can be disposed at a place matching the user's preference, facing in the desired direction.

It should be noted that a state in which the figure F is disposed in the virtual space after the movement may be controlled based on a location relationship between a polyhedron C set for the figure F and a ground in the virtual space. For example, when after the movement the figure F is placed such that the plane Cb of the polyhedron C is in contact with a ground in the virtual space, the figure F is disposed, standing in the same pose that the opponent character EC in the captured image adopts, as at the time of appearing. In addition, when the figure F is placed after the movement such that a plane different form the plane Cb of the polyhedron C is in contact with a ground in the virtual space, the figure F may be disposed, tilting more than at the time of appearing, or upside down compared to at the time of appearing.

In addition, the process of rendering an opponent character EC may be different from the process of rendering a figure F corresponding to the opponent character EC. For example, in the process of rendering the figure F, the value of roughness may be reduced, compared to the process of rendering the opponent character EC, in order to increase a gloss of the figure F compared to that of the opponent character EC. As an example, the opponent character EC may be rendered by a toon shading process, and the figure F may be rendered by a physically based rendering process (non-metal physically based rendering process). Thus, when the process of rendering an opponent character EC is different from the process of rendering a figure F corresponding to the opponent character EC, the opponent character EC and the figure F can be easily visually distinguished from each other in the virtual space.

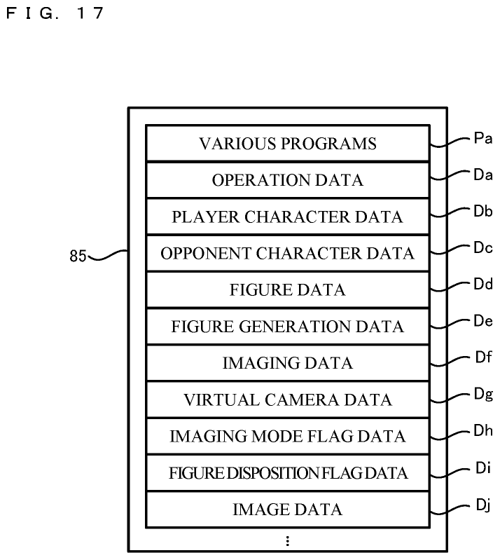

Next, an example of a specific process that is executed in the game system 1 will be described with reference to FIG. 17. FIG. 17 is a diagram illustrating an example of a data area set in the DRAM 85 of the main body apparatus 2. It should be noted that in addition to the data of FIG. 17, the DRAM 85 also stores data used in other processes, which will not be described in detail.

Various programs Pa that are executed in the game system 1 are stored in a program storage area of the DRAM 85. In the present example, the programs Pa include an application program (e.g., a game program) for performing information processing based on data obtained from the left controller 3 and/or the right controller 4 and the main body apparatus 2, and the like. Note that the programs Pa may be previously stored in the flash memory 84, may be obtained from a storage medium removably attached to the game system 1 (e.g., a predetermined type of storage medium attached to the slot 23) and then stored in the DRAM 85, or may be obtained from another apparatus via a network, such as the Internet, and then stored in the DRAM 85. The processor 81 executes the programs Pa stored in the DRAM 85.

In addition, the data storage area of the DRAM 85 stores various kinds of data that are used in processes that are executed in the game system 1 such as information processes. In the present example, the DRAM 85 stores operation data Da, player character data Db, opponent character data Dc, figure data Dd, figure generation data De, imaging data Df, virtual camera data Dg, imaging mode flag data Dh, figure disposition flag data Di, image data Dj, and the like.

The operation data Da is obtained, as appropriate, from each of the left controller 3 and/or the right controller 4 and the main body apparatus 2. As described above, the operation data obtained from each of the left controller 3 and/or the right controller 4 and the main body apparatus 2 includes information about an input from each input section (specifically, each button, an analog stick, or a touch panel) (specifically, information about an operation). In the present example, operation data is obtained from each of the left controller 3 and/or the right controller 4 and the main body apparatus 2. The obtained operation data is used to update the operation data Da as appropriate. It should be noted that the operation data Da may be updated for each frame that is the cycle of a process executed in the game system 1, or may be updated each time operation data is obtained.

The player character data Db indicates the location, direction, and pose of a player character PC that is disposed in the virtual space, and the player character PC's action, state, and the like in the virtual space.

The opponent character data Dc indicates the location, direction, and pose of an opponent character EC that is disposed in the virtual space, and the opponent character EC's action, state, and the like in the virtual state.

The figure data Dd indicates the location, direction, pose, and the like of a figure F that is disposed in the virtual space.

The figure generation data De is for causing a figure F corresponding to an imaged opponent character EC to appear.

The imaging data Df indicates images of the virtual space captured according to the user's imaging operation input, and also includes data for associating the captured images with the figure generation data.

The virtual camera data Dg indicates the location, orientation, angle of view, and the like of a virtual camera disposed in the virtual space.

The imaging mode flag data Dh indicates an imaging mode flag that is set on when the current mode is the imaging mode. The figure disposition flag data Di indicates a figure disposition flag that is set on when the event of disposing a figure F in the virtual space is being performed.

The image data Dj is for displaying an image (e.g., an image of the player character PC, an image of an opponent character EC, an image of a figure F, images of objects, a field image of the virtual space, and a background image) on a display screen (e.g., the display 12 of the main body apparatus 2).

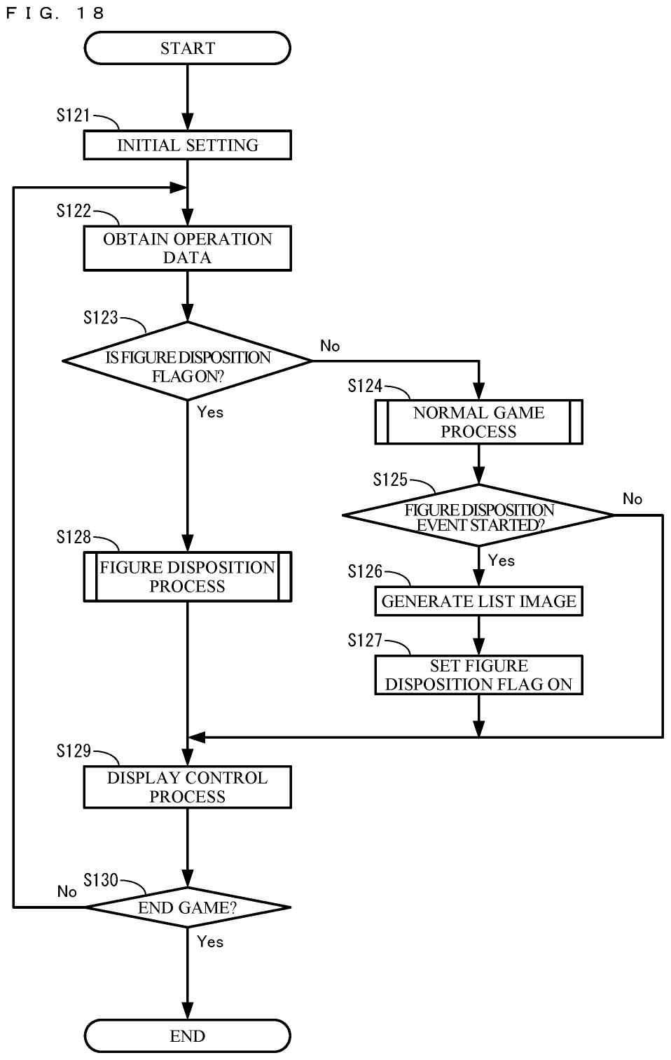

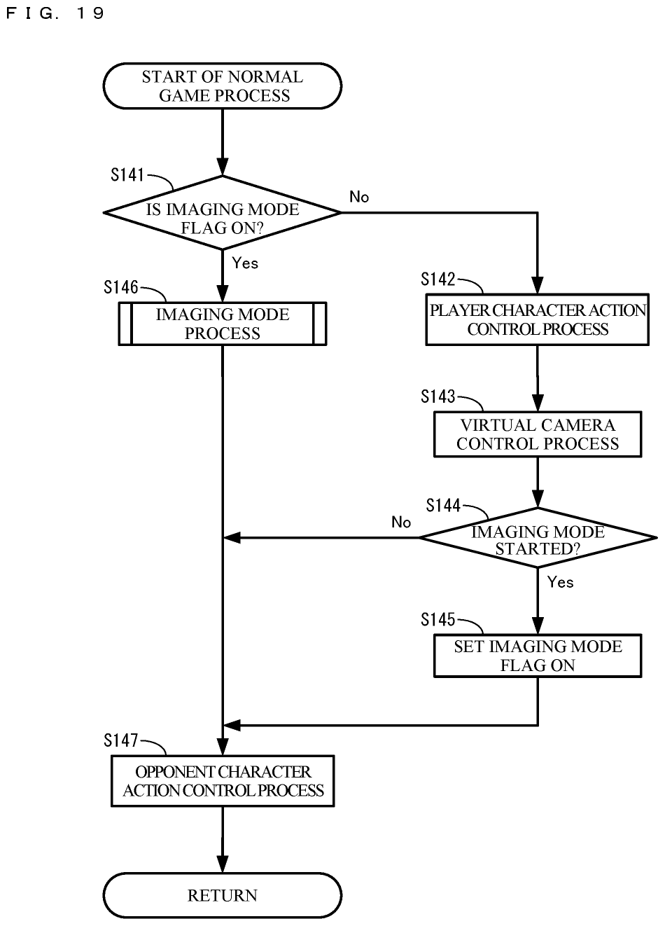

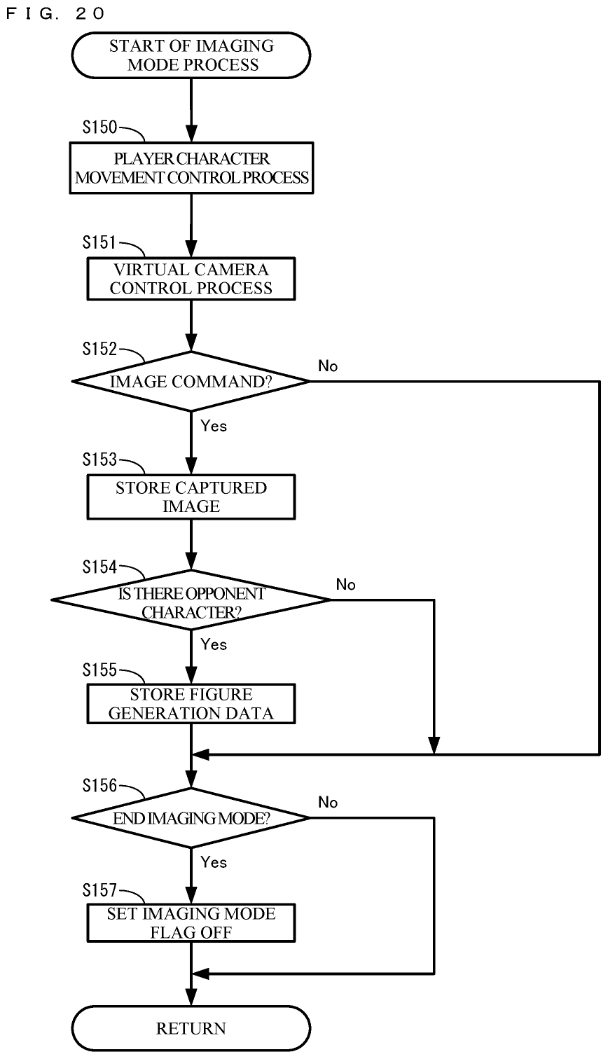

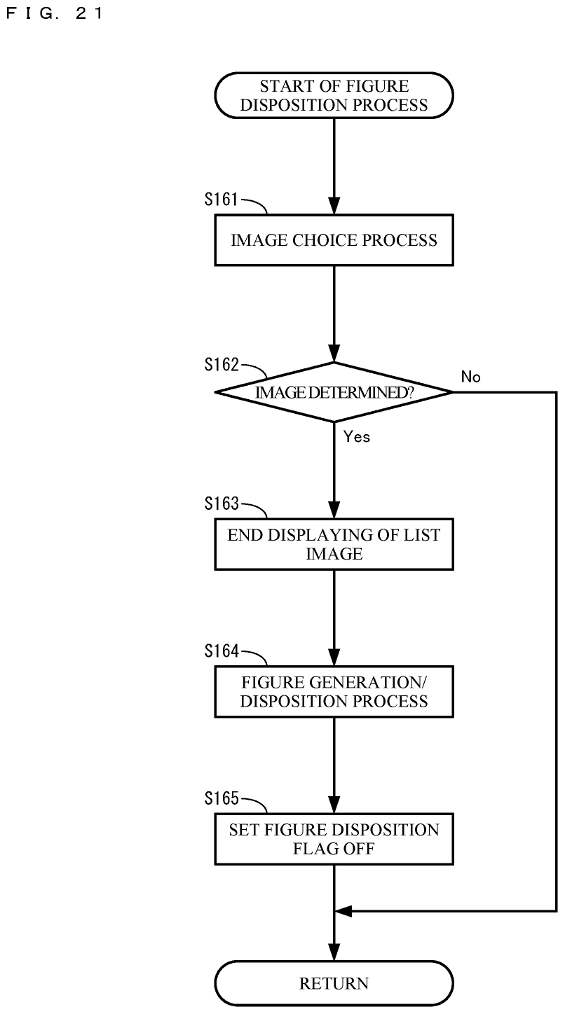

Next, a detailed example of a game process that is an example of an information process in the present example will be described with reference to FIGS. 18 to 21. FIG. 18 is a flowchart illustrating an example of a game process that is executed in the game system 1. FIG. 19 is a subroutine illustrating an example of a normal game process in step S124 of FIG. 18. FIG. 20 is a subroutine illustrating an example of an imaging mode process in step S146 of FIG. 19. FIG. 21 is a subroutine illustrating an example of a figure disposition process in step S128 of FIG. 18. In the present example, a series of steps illustrated in FIGS. 18 to 21 are executed by the processor 81 executing a predetermined application program (game program) included the programs Pa. The game process of FIGS. 18 to 21 is started with any appropriate timing.

It should be noted that the steps in the flowcharts of FIGS. 18 to 21, which are merely illustrative, may be executed in a different order, or another step may be executed in addition to (or instead of) each step, if a similar effect is obtained. In the present example, it is assumed that the processor 81 executes each step of the flowcharts. Alternatively, a portion of the steps of the flowcharts may be executed by a processor or dedicated circuit other than the processor 81. In addition, a portion of the steps executed by the main body apparatus 2 may be executed by another information processing apparatus that can communicate with the main body apparatus 2 (e.g., a server that can communicate with the main body apparatus 2 via a network). Specifically, the steps of FIGS. 18 to 21 may be executed by a plurality of information processing apparatuses including the main body apparatus 2 cooperating with each other.

In FIG. 18, the processor 81 performs initial setting for the game process (step S121), and proceeds to the next step. For example, in the initial setting, the processor 81 initializes parameters for performing steps described below, and updates each data. As an example, the processor 81 disposes a player character PC, an opponent character EC, and a virtual camera in predetermined poses or orientations at default locations in the virtual space in the initial state, and updates the player character data Db, the opponent character data Dc, and the virtual camera data Dg.

Next, the processor 81 obtains operation data from the left controller 3, the right controller 4, and/or the main body apparatus 2, updates the operation data Da (step S122), and proceeds to the next step.

Next, the processor 81 determines whether or not the figure disposition flag is on, with reference to the figure disposition flag data Di (step S123). If the figure disposition flag is off, the processor 81 proceeds to step S124. Otherwise, i.e., if the figure disposition flag is on, the processor 81 proceeds to step S128.

In step S124, the processor 81 executes a normal game process, and proceeds to step S125. The normal game process in step S124 will be described below with reference to FIG. 19.

In FIG. 19, the processor 81 determines whether or not the imaging mode flag is on, with reference to the imaging mode flag data Dh (step S141). If the imaging mode flag is off, the processor 81 proceeds to step S142. Otherwise, i.e., if the imaging mode flag is on, the processor 81 proceeds to step S146.

In step S142, the processor 81 executes a player character action control process, and proceeds to the next step. For example, the processor 81 sets an action of the player character PC based on the operation data Da. As an example, the processor 81 sets the location, direction, pose, action, state, and the like of the player character PC based on an operation input indicated by the operation data Da and virtual physical calculation (e.g., Newton's first law or Newton's law of universal gravitation) in the virtual space, and the like, and updates the player character data Db.

As an example of the player character action control process executed in step S142, a figure F already disposed in the virtual space may be moved, or may be rotated around its axis, based on the operation data Da. In that case, the processor 81 moves the figure F with the pose and appearance of the figure F indicated by the figure data Dd maintained, and updates the figure data Dd based on the location of the figure F after the movement.

Next, the processor 81 executes a virtual camera control process (step S143), and proceeds to the next step. As an example, the processor 81 changes the location and/or orientation of the virtual camera such that the player character PC is present at a predetermined location in the range of view of the virtual camera, and updates the virtual camera data Dg using the changed location and/or orientation of the virtual camera. As another example, the processor 81 changes the location and/or orientation of the virtual camera based on a predetermined algorithm, and updates the virtual camera data Dg using the changed location and/or orientation of the virtual camera.

Next, the processor 81 determines whether or not to start the imaging mode (step S144). For example, if in step S142 the processor 81 performs control that causes the player character PC to start an operation of capturing an image of the virtual space according to the user's operation input, the result of the determination by the processor 81 in step S144 is positive. If the processor 81 performs control that causes the player character PC to start an operation of capturing an image of the virtual space, the processor 81 proceeds to step S145. Otherwise, i.e., if the processor 81 does not perform control that causes the player character PC to start an operation of capturing an image of the virtual space, the processor 81 proceeds to step S147. In step S145, the processor 81 sets the imaging mode flag on, and proceeds to step S147. For example, the processor 81 sets the imaging mode flag on, and updates the imaging mode flag data Dh.

If in step S141 the processor 81 determines that the imaging mode flag is on, the processor 81 executes an imaging mode process (step S146), and proceeds to step S147. The imaging mode process in step S146 will be described below with reference to FIG. 20.

In FIG. 20, the processor 81 executes a player character action control process (step S150), and proceeds to the next step. For example, the processor 81 sets an action of the player character PC based on the operation data Da. As an example, the processor 81 sets the location, direction, pose, action, state, and the like of the player character PC based on an operation input indicated by the operation data Da and virtual physical calculation (e.g., Newton's first law or Newton's law of universal gravitation) in the virtual space, and the like, and updates the player character data Db.

Next, the processor 81 executes a virtual camera control process (step S151), and proceeds to the next step. As an example, the processor 81 changes the location and/or orientation of the virtual camera so as to provide the first-person point of view of the player character PC, and updates the virtual camera data Dg using the changed location and/or orientation of the virtual camera. By displaying the virtual space as viewed from the virtual camera thus set, a game image of the virtual space as viewed by the player character PC from the camera (i.e., a subjective view) is displayed on the display screen.

Next, the processor 81 determines whether or not the user has performed an imaging operation input, with reference to the operation data Da (step S152). If the user has performed an imaging operation input, the processor 81 proceeds to step S153. Otherwise, i.e., if the user has not performed an imaging operation input, the processor 81 proceeds to step S157.

In step S153, the processor 81 stores a captured image, and proceeds to the next step. For example, the processor 81 adds a display image of the virtual space as a newly captured image to the imaging data Df.

Next, the processor 81 determines whether or not an opponent character EC has been imaged as a subject of the captured image stored in step S153 (step S154). For example, if the area of the opponent character EC captured in the image is at least a predetermined area, the result of the determination by the processor 81 in step S154 is positive. If the opponent character EC has been imaged, the processor 81 proceeds to step S155. Otherwise, i.e., if the opponent character EC has not been imaged, the processor 81 proceeds to step S156.

In step S155, the processor 81 stores the figure generation data, and proceeds to step S156. For example, from the captured image stored in step S153, the processor 81 extracts an opponent character EC for which a figure F is to be generated, sets figure generation data based on the extracted opponent character EC, and adds the figure generation data to the figure generation data De. In addition, the processor 81 associates the captured image stored in step S153 with the generated figure generation data, and updates the imaging data Df. It should be noted that a method for setting the figure generation data is similar to that described with reference to FIGS. 12 to 15 and therefore will not be herein described in detail.

In step S156, the processor 81 determines whether or not to end the imaging mode. For example, if the user has performed an imaging operation input or an operation of ending the imaging mode, the result of the determination by the processor 81 in step S156 is positive. If the processor 81 determines to end the imaging mode, the processor 81 proceeds to step S157. Otherwise, i.e., if the processor 81 does not determine to end the imaging mode, the processor 81 ends the subroutine.

In step S157, the processor 81 sets the imaging mode flag off, and ends the subroutine. For example, the processor 81 sets the imaging mode flag off, and updates the imaging mode flag data Dh.

Referring back to FIG. 19, in step S147, the processor 81 executes an opponent character action control process, and ends the subroutine. For example, the processor 81 controls an action of each opponent character EC disposed in the virtual space under rules previously determined in the game program, and updates the opponent character data Dc.

Referring back to FIG. 18, after the normal game process in step S124, the processor 81 determines whether or not to start a figure disposition event (step S125). For example, if in step S142 the processor 81 has performed control that causes the player character PC to start an action of disposing a figure in the virtual space, according to the user's operation input, the result of the determination by the processor 81 in step S125 is positive. If the processor 81 determines to start the figure disposition event, the processor 81 proceeds to step S126. Otherwise, i.e., if the processor 81 does not determine to start the figure disposition event, the processor 81 proceeds to step S129.

In step S126, the processor 81 creates a list of captured images stored (list image), and proceeds to the next step. For example, the processor 81 executes a process of generating a game image showing a list of captured image stored in the imaging data Df (see FIG. 10).

Next, the processor 81 sets the figure disposition flag on (step S127), and proceeds to step S129. For example, the processor 81 sets the figure disposition flag on, and updates the figure disposition flag data Di.

If in step S123 the processor 81 determines that the figure disposition flag is on, the processor 81 executes a figure disposition process (step S128), and proceeds to step S129. The figure disposition process in step S128 will be described below with reference to FIG. 21.

In FIG. 21, the processor 81 executes a process of choosing a captured image from a list of captured images displayed (step S161), and proceeds to the next step. For example, the processor 81 designates one from a list of captured images displayed, based on the operation data Da, or changes the designated captured image. It should be noted that the processor 81 may add a cursor to the designated captured image or display the designated captured image in a different display form in order to distinguish the designated captured image from the other captured images. In addition, the processor 81 may scroll the list of captured images displayed, based on the operation data Da.

Next, the processor 81 determines whether or not the designation of a captured image has been confirmed (step S162). For example, if the operation data Da indicates an operation of confirming the designation of a captured image, the result of the determination by the processor 81 in step S162 is positive. If the designation of a captured image has been confirmed, the processor 81 proceeds to step S163. Otherwise, i.e., if the designation of a captured image has not been confirmed, the processor 81 ends the subroutine.

In step S163, the processor 81 ends displaying of the list of captured images (list image), and proceeds to the next step.

Next, the processor 81 executes a process of generating a figure F associated with the confirmed captured image and disposing the figure F in the virtual space (step S164), and proceeds to the next step. For example, the processor 81 retrieves figure generation data associated with the confirmed captured image from the figure generation data De, with reference to the imaging data Df. Thereafter, the processor 81 causes the figure F to appear in the virtual space based on the retrieved figure generation data, and updates the figure data Dd based on the location and pose of the figure F that has appeared. It should be noted that a method for causing a figure F to appear based on the figure generation data is similar to that described with reference to FIGS. 11 to 16 and therefore will not be herein described in detail.

It should be noted that if the confirmed captured image is not associated with any figure generation data, the processor 81 may execute a process of continuing to display the confirmed captured image until a predetermined condition is satisfied in step S164. The predetermined condition is that the user has performed an operation of ending continuation of displaying, that a predetermined period of time has passed, or the like.

Next, the processor 81 sets the figure disposition flag off (step S165), and ends the subroutine. For example, the processor 81 sets the figure disposition flag off, and updates the figure disposition flag data Di.

Referring back to FIG. 18, in step S129, the processor 81 executes a display control process, and proceeds to the next step. As an example, the processor 81 disposes objects such as the player character PC, the opponent character EC, and the figure F in the virtual space based on the player character data Db, the opponent character data Dc, the figure data Dd, and the like. In addition, the processor 81 sets the location and/or orientation of the virtual camera for generating a display image, based on the virtual camera data Dg, and disposes the virtual camera in the virtual space. Thereafter, the processor 81 performs control that generates an image of the virtual space as viewed from the set virtual camera, and displays the virtual space image on the display 12. As another example, if in steps S126, S161, and S164 a list of captured images or a captured image is set as a display image, the processor 81 performs control that displays the display image on the display 12.

Next, the processor 81 determines whether or not to end the game process (step S130). In step S130, the game process is ended, for example, if a condition for ending the game process is satisfied, the user has performed an operation of ending the game process, or the like. If the processor 81 does not determine to end the game process, the processor 81 returns to step S122, and repeats the process. Otherwise, i.e., if the processor 81 determines to end the game process, the processor 81 ends the flowchart. Following this, steps S122 to S130 are repeatedly executed until the processor 81 determines to end the game process in step S130.

Thus, in the present example, a figure F having the same 3D model as that of an opponent character EC as a subject in a captured image of a virtual space based on the user's operation input can be caused to appear in the virtual space, adopting a pose based on the opponent character EC. Therefore, the user can enjoy the figure F disposed, adopting the pose desired by the user, as a novel collection element.

It should be noted that a captured image stored in the present example and figure generation data associated with the captured image may be configured to be able to be transmitted to other information processing apparatuses. For example, when the user of the game system 1 transmits and receives a pair of the captured image and the figure generation data to and from other information processing apparatuses using the first or second communication form, a figure F based on the figure generation data can be caused to appear in a virtual space in an apparatus that is a transmission destination, so that a novel collection element can be exchanged between users.

The game system 1 may be any suitable apparatus, including handheld game apparatuses, personal digital assistants (PDAs), mobile telephones, personal computers, cameras, tablet computers, and the like.

In the foregoing, the information process (game process) is performed in the game system 1 by way of example. Alternatively, at least a portion of the process steps may be performed in another apparatus. For example, when the game system 1 can also communicate with another apparatus (e.g., a server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above example, the information processes can be performed by the processor 81 of the game system 1 executing predetermined programs. Alternatively, all or a portion of the above processes may be performed by a dedicated circuit included in the game system 1.

Here, according to the above variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of step S may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example.

The above programs may be supplied to the game system 1 not only through an external storage medium, such as an external memory, but also through a wired or wireless communication line. The program may be previously stored in a non-volatile storage device in the game system 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

As described above, the present example is applicable as a game program, game system, game apparatus, game processing method, and the like that are capable of providing a novel collection element that can be stored in a game.

What is claimed is:

1. A non-transitory computer-readable storage medium having stored therein instructions that, when executed, cause one or more processors of an information processing apparatus to execute game processing comprising:
controlling at least a pose that a first object having a first 3D model adopts in a virtual space;
according to a first command based on an operation input, storing at least first pose data related to the pose of the first object at the time of the first command into a storage; and
according to a second command based on an operation input, disposing a second object having the first 3D model in the virtual space, in a pose based on the first pose data.

2. The non-transitory computer-readable storage medium according to claim 1, wherein
the game processing further comprises:
according to the first command, generating a first image including the first object obtained by imaging at least a portion of the virtual space as viewed from a virtual camera at the time of the first command; and
additionally storing the first image into the storage.

3. The non-transitory computer-readable storage medium according to claim 2, wherein
information indicating the first 3D model and the first pose data are stored into the storage in association with the first image.

4. The non-transitory computer-readable storage medium according to claim 2, wherein
the game processing further comprises:
displaying a list of images including the first image or images, and
when one of the first images is designated based on a third command based on an operation input during displaying of the list of images, the second object having the same first 3D model as that of the first object related to the designated first image is disposed in the virtual space, in a pose based on the first pose data.

5. The non-transitory computer-readable storage medium according to claim 1, wherein
the first object includes a plurality of bones used in control of the first 3D model, and
the first pose data includes data indicating a state of the plurality of bones at the time of the first command.

6. The non-transitory computer-readable storage medium according to claim 1, wherein
for the first object, an animation in which an appearance thereof is changed, depending on a condition, is set,
animation state data related to a state of the animation of the first object at the time of the first command is additionally stored into the storage, and
according to the second command, the second object is disposed in the virtual space, in a pose based on the first pose data and with an appearance based on the animation state data.

7. The non-transitory computer-readable storage medium according to claim 1, wherein
the game processing further comprises:
rendering the first object in the virtual space by a first rendering process; and
rendering the second object disposed in the virtual space by a second rendering process different from the first rendering process.

8. The non-transitory computer-readable storage medium according to claim 1, wherein
the game processing further comprises:
moving the second object in the virtual space based on an operation input, with the pose based on the first pose data maintained.

9. The non-transitory computer-readable storage medium according to claim 1, wherein
the game processing further comprises:
moving the second object in the virtual space based on an operation input, with local coordinates of the second object at the time of the disposition of the second object in the virtual space fixed.

10. The non-transitory computer-readable storage medium according to claim 1, wherein
according to the first command, type data indicating a type of a character related to the first object is additionally stored, together with the first pose data, into the storage; and
according to the second command, a character of a type based on the type data in the virtual space is disposed in a pose based on the first pose data.

11. The non-transitory computer-readable storage medium according to claim 1, wherein
the first object is equipped with at least one first equipment object at a part thereof,
according to the first command, equipment data indicating a type of the first equipment object is additionally stored into the storage, in addition to the first pose data at the time of the first command, and
according to the second command, the second object is disposed in the virtual space, in a pose based on the first pose data with a second equipment object related to the equipment data attached to the part of the second object.

12. The non-transitory computer-readable storage medium according to claim 11, wherein
the game processing further comprises:
controlling a player character in the virtual space based on an operation input;
controlling the first object's action of attacking the player character using the first equipment object in the virtual space; and
even when the first command is given during the first object's action of attacking, storing, into the storage, the first pose data and the equipment data at the time of the first command.

13. The non-transitory computer-readable storage medium according to claim 1, wherein
the game processing further comprises:
setting a polyhedron enclosing the second object, and
the second object is disposed in a pose based on the first pose data with one of the surfaces of the polyhedron in contact with a ground in the virtual space.

14. A game system comprising:
one or more processors; and
one or more memories storing instructions that, when executed, cause the game system to perform operations including:
controlling at least a pose that a first object having a first 3D model adopts in a virtual space;
according to a first command based on an operation input, storing at least first pose data related to the pose of the first object at the time of the first command into a storage; and
according to a second command based on an operation input, disposing a second object having the first 3D model in the virtual space, in a pose based on the first pose data.

15. The game system according to claim 14, wherein
a first image including the first object at the time of the first command is additionally stored into the storage.

16. The game system according to claim 15, wherein
information indicating the first 3D model and the first pose data are stored into the storage in association with the first image.

17. The game system according to claim 15, wherein
further, a list of images including the first image or images is displayed, and
when one of the first images is designated based on a third command based on an operation input during displaying of the list of images, the second object having the same first 3D model as that of the first object related to the designated first image is disposed in the virtual space, in a pose based on the first pose data.

18. The game system according to claim 14, wherein
the first object includes a plurality of bones used in control of the first 3D model, and
the first pose data includes data indicating a state of the plurality of bones at the time of the first command.

19. The game system according to claim 14, wherein
for the first object, an animation in which an appearance thereof is changed, depending on a condition, is set, and
animation state data related to a state of the animation of the first object at the time of the first command is additionally stored into the storage, and
according to the second command, the second object is disposed in the virtual space, in a pose based on the first pose data and with an appearance based on the animation state data.

20. The game system according to claim 14, wherein, further,
the first object in the virtual space is rendered by a first rendering process, and
the second object disposed in the virtual space is rendered by a second rendering process different from the first rendering process.

21. The game system according to claim 14, wherein, further,
the second object is moved in the virtual space based on an operation input, with the pose based on the first pose data maintained.

22. The game system according to claim 14, wherein, further,
the second object is moved in the virtual space based on an operation input, with local coordinates of the second object at the time of the disposition of the second object in the virtual space fixed.

23. The game system according to claim 14, wherein
according to the first command, type data indicating a type of a character related to the first object is additionally stored, together with the first pose data, into the storage, and
according to the second command, a character of a type based on the type data is disposed in the virtual space, in a pose based on the first pose data.

24. The game system according to claim 14, wherein
the first object is equipped with at least one first equipment object at a part thereof,
according to the first command, equipment data indicating a type of the first equipment object is additionally stored into the storage, in addition to the first pose data at the time of the first command, and
according to the second command, the second object is disposed in the virtual space, in a pose based on the first pose data with a second equipment object related to the equipment data attached to the part of the second object.

25. The game system according to claim 24, wherein, further,
a player character is controlled in the virtual space based on an operation input,
the first object's action of attacking the player character using the first equipment object is controlled in the virtual space, and
even when the first command is given during the first object's action of attacking, the first pose data and the equipment data at the time of the first command are stored into the storage.

26. The game system according to claim 14, wherein
further, a polyhedron enclosing the second object is set, and
the second object is disposed in a pose based on the first pose data with one of the surfaces of the polyhedron in contact with a ground in the virtual space.

27. A game apparatus comprising:
one or more processors; and
one or more memories storing instructions that, when executed, cause the game apparatus to perform operations including:
controlling at least a pose that a first object having a first 3D model adopts in a virtual space;
according to a first command based on an operation input, storing at least first pose data related to the pose of the first object at the time of the first command into a storage; and
according to a second command based on an operation input, disposing a second object having the first 3D model in the virtual space, in a pose based on the first pose data.

28. A game processing method for causing one or more processors of an information processing apparatus to at least:
control at least a pose that a first object having a first 3D model adopts in a virtual space;
according to a first command based on an operation input, store at least first pose data related to the pose of the first object at the time of the first command into a storage; and
according to a second command based on an operation input, dispose a second object having the first 3D model in the virtual space, in a pose based on the first pose data.
